(19) United States
(12) Patent Application Publication
(10) Pub. No.: US 2017/0070684 A1
(43) Pub. Date: Mar. 9, 2017

(54) System and Method for Multimedia Enhancement

(71) Applicants: Roberto Sonabend, Cuajimalpa (MX); Jose Luis Almeida, Cuajimalpa (MX)

(72) Inventors: Roberto Sonabend, Cuajimalpa (MX); Jose Luis Almeida, Cuajimalpa (MX)

(21) Appl. No.: 15/272,967

(22) Filed: Sep. 22, 2016

Related U.S. Application Data
(63) Continuation-in-part of application No. 14/867,422, filed on Sep. 28, 2015, now Pat. No. 9,479,713.
Application No. 14/867,422 is a continuation of application No. PCT/US2013/052236, filed on Jul. 26, 2013.

(51) Int. Cl. H04N 5/272; H04N 5/60; H04N 5/445

(52) U.S. Cl. CPC H04N 5/2723; H04N 5/44504; H04N 5/60

(57) ABSTRACT

A system and method of enhancing a multimedia information stream is disclosed in which a display-object, displayed on changeable signage-display located at a venue, and visible to spectators at the venue, is incorporated into a multi-media presentation so that, to a media audience, the multi-media presentation is enhanced by an agent-object that is only visible to the media audience, and which appears to that audience to be actually at the venue and to be interacting with the changing display-object on the signage-display at the venue. The agent-object is a computer generated cartoon character, or an actor and an associated audio track. The enhancement is effected using match moving technology.

### CROSS-REFERENCE TO RELATED APPLICATIONS

This is a US continuation-in-part application of U.S. application Ser. No. 14/867,422 entitled “Method of Video Enhancement” filed on Sep. 28, 2015 by inventors Roberto Sonabend and Jose Luis Almeida, that in turn is a US continuation application of International Application PCT/US2013/052236 entitled “Method of Video Enhancement” filed by inventors Roberto Sonabend and Jose Luis Almeida with an international filing date of Jul. 26, 2013, the contents of both of which are hereby incorporated by reference in their entirety.

### BACKGROUND OF THE INVENTION

(1) Field of the Invention

The invention relates to a method of enhancing a multimedia presentation, and more particularly, to a method of synchronizing a virtual addition to a multimedia video and/or audio sequence using match moving technology, and more preferably to accomplishing the enhancement for a real event in real time.

(2) Description of the Related Art

The technical problem of synchronizing audio and visual assets obtained from different source is inherent in the technical field of multimedia production.

A particular technical problem that may be of great interest to multimedia producers of events is of how to synchronize assets produced by different sources so that it appears to a viewer of the composite multimedia production that the assets from the different sources were all present in a particular venue, and that the assets from the different sources appear to causally interact with one another. The problem is of particular interest to producers of broadcasts, or multimedia distributions, of live events such as, but not limited to, sporting events for the purpose of, for instance, advertising.

The relevant prior art includes:

US Patent Application 20070197247 published by E. Inselberg on Aug. 23, 2007 entitled “Method and apparatus for interactive participation at a live entertainment event” that describes a method and apparatus that provide interactive participation at live entertainment events. Enjoyment for a plurality of participants is enhanced. Participants employ wireless interactive devices that present a promotional message and include user input and output interfaces. Participants are queried, and enter wagers via the user input interface. The wagers are transmitted to a central processor, stored as participant data, and processed into results. A visual display or the user output interface announces the results to the participants.

U.S. Pat. No. 5,264,933 issued to Rosser, et al. on Nov. 23, 1993 entitled “Television displays having selected inserted indicia” that describes an apparatus and method of altering video images to enable the addition of images, message, slogans or indicia in such a manner that they appear to be part of the original image as displayed. The application of the apparatus and method is particularly adapted to be used as advertising during sporting events or other events whereby an operator selects a portion of the video image display (16) such as a portion of a tennis court (12) recognizes the selected portion (17) and inserts a logo or advertising message (27) into that selected portion. The message is inserted into the selected portion of the court independent of how the scene is being panned or viewed by the television camera. The apparatus employs a pattern recognition algorithm such as the Burt Pyramid Algorithm to recognize the specific selected image portion and by means of the image processor (17, 20 and 27) substitute the logo into the first image (16) to provide a display which appears as if the inserted image was actually painted on or otherwise permanently positioned on the court. Thus the inserted images are seamlessly and realistically incorporated into the original even as the original scene is moved, panned, magnified, zoomed or otherwise altered in size or perspective. The resulting composite image appears to the television viewer to be absolutely real and present at the scene.

U.S. Pat. No. 6,750,919 issued to Rosser on Jun. 15, 2004 entitled “Event linked insertion of indicia into video” that describes a system and method for placing event related information into a video broadcasting so that the added information does not interfere with or obscure the primary action of interest in the broadcast. The disclosed information could be implemented by using instructions from an event information gathering system to trigger the display of one of an appropriate set of pre-rendered animations in the broadcast video via a well-known live video insertion system (48). The disclosed invention envisages the animation sequence having at least two parts (FIG. 4), namely a core or base sequence (34) which is always used, and a mid or a variable sequence (56, 58, 60) which is changed according to the actual data that needs to be displayed. The live video insertion system data (48) and processing may be used to perform occlusion, and/or tracking to either make the event information display look as if it is part of the scene, or merely to occlude the display when event action would otherwise be obscured, or to turn off or reposition, or resize the display when event action otherwise be obscured.

Various implementations are known in the art, but fail to address all of the problems solved by the invention described herein. Various embodiments of this invention are illustrated in the accompanying drawings and will be described in more detail herein below.

### BRIEF SUMMARY OF THE INVENTION.

An inventive system and method of enhancing a multimedia information stream is disclosed.

In a preferred embodiment, a changeable signage-display unit may be located at a venue at which an event may be occurring. The locally-located, changeable signage-display may, for instance, be displaying a display-object that may be visible to spectators present at the venue and watching or participating in the event. The changeable signage-display may, for instance, be, but is not limited to, an LED enabled perimeter advertising sign at a soccer stadium. The event may also be being made available to a media audience via a multimedia distribution. The media audience may be able to view the either live or via a delay on a multimedia display device.

The multimedia information stream being supplied to the media audience may be enhanced by having an agent-object that is only visible to the media audience and which may appear to that audience to be actually at the venue and to be interacting with a changing display-object on the signage-display at the venue. The agent-object may, for instance, be a computer generated cartoon character, or an actor, or a combination thereof, and an associated audio track.

The agent-object may be made to appear to be at the venue and interacting with a display-object being shown on the signage-display at the venue by, for instance, the used of a match moving system and methodology.

In a preferred embodiment, this may be accomplished by first initiating a change of the display-object that is visible both to the spectators present at the venue and to the media audience. The system may also have the agent-object perform one or more actions, that may be timed or executed so as to coincide with the change of the display-object. The agent-object and its actions may be visible and audible only to the media audience, and not to the audience at the venue. By suitable timing and the use of match moving, the agent-object may be made to appear to the media audience to be real, to be at the venue, and to be causing the change occurring in the display-object. Match moving is a well-known cinematic technique that allows the insertion of computer graphics into live-action footage with correct position, scale, orientation, and motion relative to the photographed objects in the shot.

### BRIEF DESCRIPTION OF THE SEVERAL VIEWS OF THE DRAWINGS.

FIG. 1A shows a schematic view of an enhanced multimedia information stream of one embodiment of the present invention as displayed on a multimedia viewing device.

FIG. 1B shows a further schematic view of an enhanced multimedia information stream of one embodiment of the present invention as displayed on a multimedia viewing device.

FIG. 2 shows a schematic view of possible elements of a system in accordance with one embodiment of the present invention.

FIG. 3 shows a schematic flow diagram of representative steps in implementing one embodiment of the present invention.

FIG. 4 shows a further schematic flow diagram of representative steps in implementing one embodiment of the present invention.

### DETAILED DESCRIPTION OF THE INVENTION

The preferred embodiments of the present invention will now be described in more detail with reference to the drawings in which identical elements in the various figures are, as far as possible, identified with the same reference numerals. These embodiments are provided by way of explanation of the present invention, which is not, however, intended to be limited thereto. Those of ordinary skill in the art may appreciate upon reading the present specification and viewing the present drawings that various modifications and variations may be made thereto without departing from the spirit of the invention.

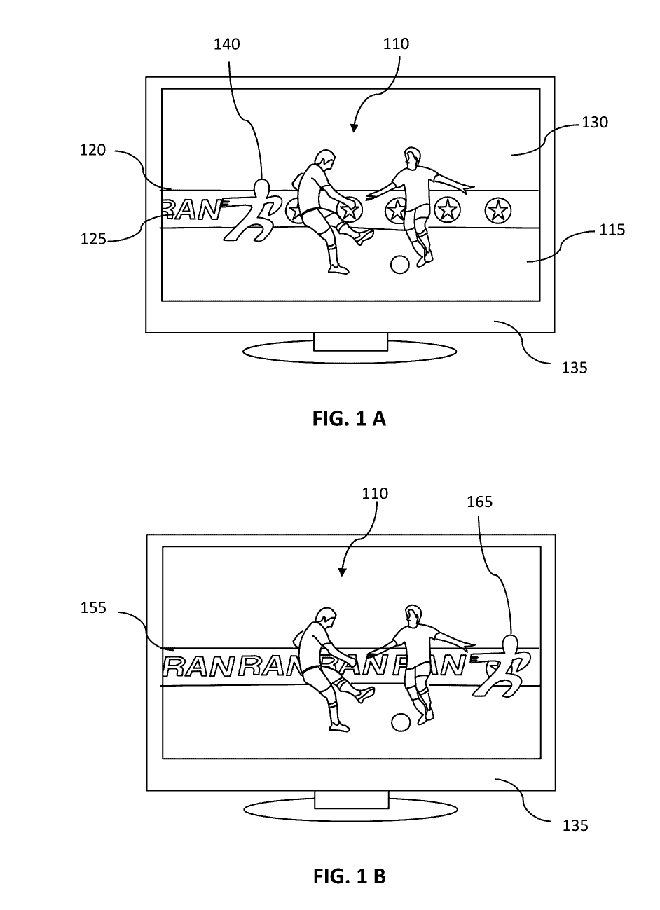

FIG. 1A shows a schematic view of an enhanced multimedia information stream of one embodiment of the present invention as displayed on a multimedia viewing device.

A multimedia viewing device 135 is shown in FIG. 1 displaying an image of an event 110 being played or performed at a venue 115. A locally-located, changeable signage-display 120 may be seen that is located at the venue in which the event may be occurring. The locally-located, changeable signage-display 120 is shown displaying a display-object 125. An agent-object 140 is also shown in the image on the multimedia viewing device 135. The display-object 125 may be visible and audible to both the spectators 130 at the venue as well as to the media audience watching and listening to the multimedia distribution on a multimedia viewing device 135. The agent-object 140, however, may only be visible and audible only to the media audience, and not to the spectators 130 at the venue.

FIG. 1B shows a further schematic view of an enhanced multimedia information stream of one embodiment of the present invention as displayed on a multimedia viewing device.

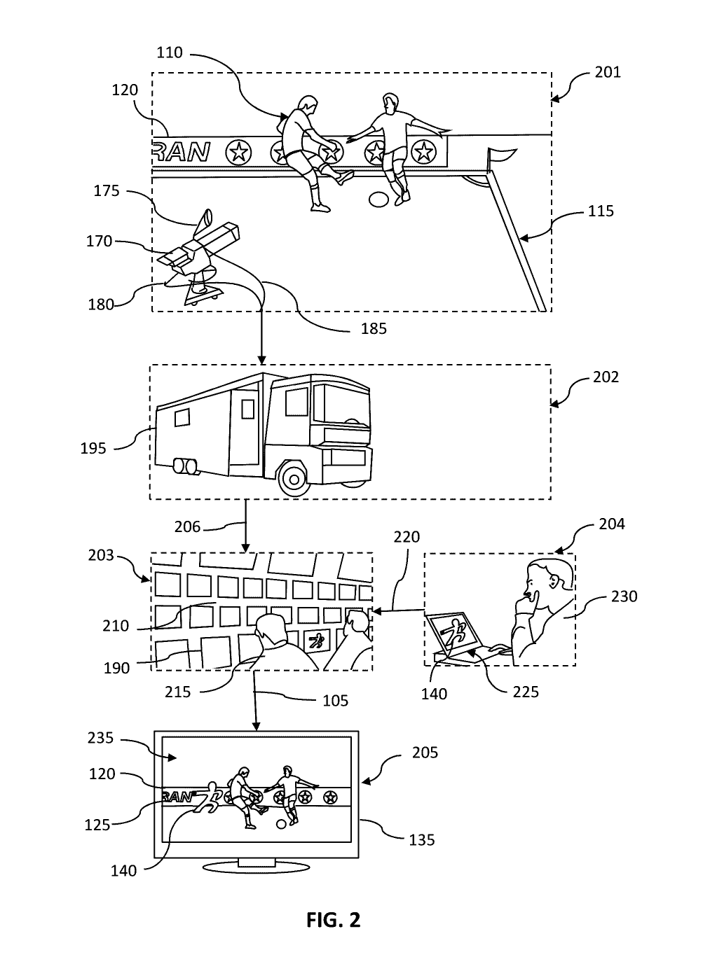

In FIG. 1B, the performing object-agent 165 has been made to move, appearing to travel to the right of the screen. In addition, a changed display-object 155 may be displayed. In FIG. 2 the display object is an advertising logo that has been made to appear to also travel along the screen to the right. In a preferred embodiment the changes or movements of the performing object-agent 165 may be choreographed and timed to coincide with the changes in the display-object so that to the media audience the performing object-agent 165 appears to be at the venue and to be casually effecting the changes in the display-object.

The multimedia viewing device 135 may be any suitable device such as, but not limited to, to television set, a smart phone, a computer screen, a note pad device, a portable computer, a video game console or some combination thereof. The enhanced multimedia information stream may be distributed to the multimedia viewing device 135 from a production facility that may be at the venue, or have production equipment at the venue staging the event. This distribution may be via a network such as, but not limited to, a television broadcast network, a cable television network, the Internet, a digital communications network, a wired or wireless telephone network, or some combination thereof. The production and the distribution of the enhanced multimedia content may occur live, or after a delay that may be from minutes to a few hours or to days. The delay may, for instance, be necessary to adjust the distribution of the content to match the time zone of all, or part, of the media audience. The event may, for instance, be a live event such as, but not limited to, a sporting event such as, but not limited to, a soccer game, a football game, a baseball game, or it may be a theatrical event, a music concert, or a political event, or some combination thereof. The venue may, for instance, be an event holding facility such as, but not limited to, a sports arena or stadium, an event location such as, but not limited to, a swimming pool, a rowing course, a yachting course, a marathon course, or it may be a concert hall or a theatre, or some combination thereof. The locally-located, changeable signage-display 120 may, for instance, be some adjustable display device such as, but not limited to, a perimeter advertising board that may incorporate an LED display or a rotating sign display, a Jumbo Tron device, or some combination thereof. The display-object 125 may, for instance, be a sponsored message such as, but not limited to, an advertising sign or slogan, or a video and audio multimedia advertising presentation, a political or social message or commentary, or some combination thereof. The agent-object 140 may, for instance, be a multi-media component incorporating video and associated audio such as, but not limited to, a computer generated cartoon sequence, a Claymation animation, one or more actors performing actions, including singing and or spoken dialogue, recorded or synthetic audio effects, or some combination thereof. Combining the multimedia depiction of the display-object 125 and the agent-object 140 may be accomplished by match moving technology such as, but not limited to, to technology described in U.S. Pat. Nos. 5,264,933 and 6,750,919, the contents of both of which are hereby incorporated by reference in their entirety. Match moving is a well-known cinematic technique that allows the insertion of computer graphics into live-action footage with correct position, scale, orientation, and motion relative to the photographed objects in the shot.

In combination, FIGS. 1A and 1B show how an agent-object 140, that in this instance may be a computer generated animation of a human-like figure, may be made to appear in a television broadcast of a soccer match occurring in a soccer stadium in such a way that the computer animation appears, to the television viewing audience, to be at the soccer match and to be actively dragging a changing advertising sign along a perimeter LED signage display.

Although FIGS. 1A and 1B may be interpreted as a specific example of the concepts and use of the present invention, they are intended to be merely representative of the invention and are in no way intended to limit the use of the invention or inventive concepts to the situation they are intended to depict.

FIG. 2 shows a schematic view of possible elements of a system for enhancing a multimedia information stream in accordance with one embodiment of the present invention.

A first window 201 of FIG. 2 may depict an event 110 occurring at a venue 115 that may, for instance, be being televised for live, or delayed, transmission to a media audience. This may, for instance, be accomplished using equipment such as, but not limited to, one or more broadcast quality cameras 170 and one or more broadcast quality microphone 175. The cameras and microphones may be used to produce one or more primary image sources 180 and one or more primary audio sources 185. In a preferred embodiment both image and audio sources may be streams of digital data formatted in one or more of the well-known digital video and audio formats such as, but not limited to, the MPEG digital formats or the WAV digital formats, or some combination thereof.

The primary image source 180 and the primary audio source 185 may then be delivered to a production facility. This production facility may, for instance, be a broadcast truck 195 as depicted in a second window 202 of FIG. 2. The broadcast truck 195 may contain equipment and personal that may produce a combined or an enhanced multimedia information stream, or the broadcast truck 195 may simply relay the digital sources on to a central production studio where the sources are combined.

A third window 203 of FIG. 2 may depict a facility containing broadcast equipment 210 and personal such as, but not limited to, a program director 215. The facility may be housed in a broadcast truck located at the venue, or it be located all, or in part, at a studio remote from the venue. A primary multimedia feed 206 may, for instance, be fed from the venue via the broadcast truck 195 over a digital communications network, such as, but not limited to, the Internet, a satellite digital communications network, a wired or wireless telephone network, or some combination thereof.

The broadcast equipment 210 may include items such as, but not limited to, a match-moving graphics and audio engine 190. The match-moving graphics and audio engine 190 may, for instance, be combine the primary multimedia feed 206 originating from the venue with one or more secondary image and audio sources 220.

A fourth window 204 of FIG. 2 may depict how the secondary image and audio sources 220 may be produced by a graphic artist 230 using computer graphics equipment 225. The artist may use the equipment to produce an agent-object 140 that may be programmed to perform actions and utterances that may be choreographed so as to be used in conjunction with images and audio of the display-object appearing on the changeable signage-display 120 located at the venue.

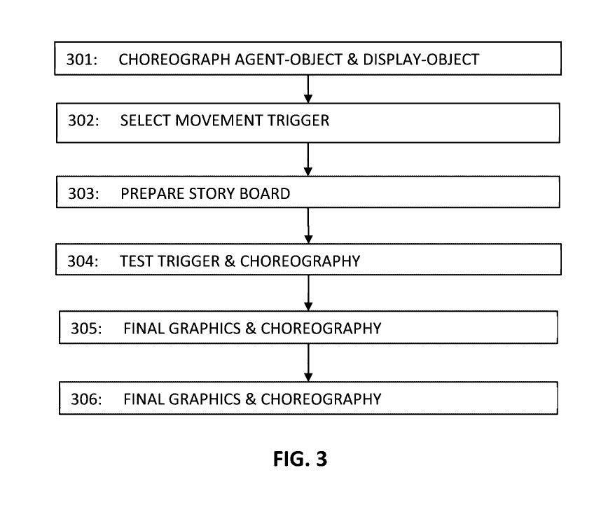

A fifth window 205 of FIG. 3 may depict a composite audiovisual image 235 being displayed on a multimedia viewing device 135 for one of the media audience to view. The composite audiovisual image 235 may be part of a multimedia distribution 105 that may be delivered via a digital data network such as, but not limited to, the Internet, a television broadcast network, a television cable network, a digital wired or wireless telephone network, or some combination thereof. In the composite audiovisual image 235 the agent-object 140 may now appear to the media audience to be at the venue and to be causally interacting with the display-object 125 being displayed on the locally-located, changeable signage-display 120. In a preferred embodiment, this enhancement may be effected in real-time on the broadcast, or multi-media distribution, of a live event.

FIG. 3 shows a schematic flow diagram of representative steps in implementing one embodiment of the present invention.

In Step 301: “Choreograph Agent-Object & Display-Object”, a desired video effect may be envisaged, i.e., the desired interaction between the agent-object and the display-object that may appear on the final composite or broadcast video. The interaction may need to be choreographed in some detail.

In Step 302: “Select Movement Trigger”, it may be necessary to decide on how the desired movement of the agent-object and of the display-object will be triggered. Triggers may include events such as, but not limited to, a signal from the program director, or their agent, a predetermined time during the game at which to start the sequence, one or more timing sequences triggered by a camera moving to a particular point of view, or having a particular state of orientation and zoom, or an object being recognized in the live video, or some combination thereof.

In Step 303: “Prepare Story Board”, it may be necessary to prepare preliminary story boards of the images intended to be used for displaying both the agent-object and the display-object.

In Step 304: “Test Trigger & Choreography”, it may be necessary to test the preliminary story boards to ascertain that they will function as desired with the selected images, triggering and synchronization. Any adjustments may then be made before preparing the final, detailed graphics.

In Step 305: “Final Graphics & Choreography”, it may be necessary to prepare the final graphics to be used for the display-object and for the agent-object if it is to be animated. If the agent-object is to be live, it may be necessary to prepare a detailed choreography, i.e., the position, timing and movement of the actor that will be filmed as the live or prerecorded agent-object. The movement of the agent-object and the changes in the display-object may, for instance, be choreographed so as the two objects appear to be physically influencing each other's motion.

In Step 306: “Final Graphics & Choreography”, may be possible to produce the live broadcast incorporating the desired video enhancement.

This may, for instance, be done with a system in which there is a display-object. The display-object may, for instance, be being displayed on a changeable signage-display located locally in a venue where a real, live event that is being televised. In a preferred embodiment, the display-object may have at least one animated or moving element.

Another component that may be used to implement the method is at least one broadcast quality camera. The broadcast video camera may be positioned and functionally enabled to provide a primary image source comprising a stream of video images of the real, live event that is being televised. The stream of video images should preferably include at least a portion of an animated or moving element of the display object. This should preferably occur at least once during the televised broadcast.

Yet another component of a system to implement the method of the present invention may be a real-time, match-moving graphics engine. The real-time, match-moving graphics engine may be functionally enabled to obtain the primary image source and to combine them with one or more images, obtained from a secondary image source. The secondary image source may be of an agent-object. The combined video images may show the agent-object appearing to be causally interacting with the display-object, i.e., the agent-object may appear to causing the movement of the display-object. The display-object may, for instance, be displayed on any changeable signage-display capable of showing motion such as, but not limited to, a Jumbo Tron, a digital or rotating perimeter advertising board, animated in-stadium signage or some combination thereof.

The real-time, match-moving graphics engine may be any suitably powerful and suitable programmed general purpose computer and the input, output and storage media associated with the computer.

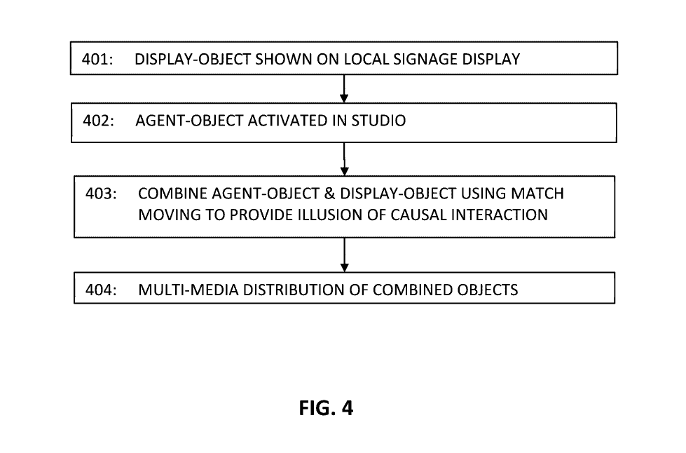

FIG. 4 shows a further schematic flow diagram of representative steps in implementing one embodiment of the present invention.

In Step 401: “Display-Object Shown On Local Signage Display”, a display-object, that may be an animated or moving advertisement or product logo, may be shown on a locally-located, changeable signage-display such as, but not limited to, a rotating perimeter board, an LED equipped, digital perimeter display, a Jumbo Tron, or some combination thereof.

In Step 402: “Agent-Object Activated in Studio”, an agent-object may be set in motion. The agent-object, which may be a pre-recorded multi-media clip, or may be pre-rehearsed performance by one or more actors, or some combination thereof, may be set in motion by a trigger that may be related to an aspect of the display-object, such as, but not limited to, but not limited to its current appearance, location, size, orientation, or some combination thereof. The trigger may also, or instead, be a signal from a program director, a predetermined time, an occurrence in the event being televised, an action by a player in the event, or some combination thereof. The purpose of the trigger may be to set the agent-object in motion so that the subsequent actions performed by the agent-object may be coordinated with the subsequent actions of the display-object.

In Step 403: “Combine Agent-Object & Display-Object Using Match Moving to Provide Illusion of Causal Interaction”, a suitably programmed digital processor may interact with the digital video and audio streams containing depictions of the display-object and digital video, and with the audio streams containing depictions of the agent-object, so as to make them appear to be in the same scene. and to be causally interacting with each other. This may, for instance, be accomplished by using match moving techniques. Match moving is a well-known cinematic technique that allows the insertion of computer graphics into live-action footage with correct position, scale, orientation, and motion relative to the photographed objects in the shot, and can be readily adapted to also insert images of one live performance into another.

In Step 404: “Multi-Media Distribution of Combined Objects” the multi-media stream having the display and agent objects depicted causally interacting with each other, may be distributed to multi-media display devices for a media audience to watch and listen to. This distribution may, for instance, be make via a digital information distribution network such as, but not limited to, a terrestrial or satellite television broadcast network, the Internet, a wired or wireless digital telephone network, a local area network (LAN), or some combination thereof.

Although this invention has been described with a certain degree of particularity, it is to be understood that the present disclosure has been made only by way of illustration and that numerous changes in the details of construction and arrangement of parts may be resorted to without departing from the spirit and the scope of the invention.

The invention claimed is:

1. A method of enhancing a multimedia information stream, comprising:
providing a multimedia distribution of an event occurring at a venue, said venue comprising a, locally-located, changeable signage-display, displaying a display-object, said display-object being visible to spectators present at said venue and to a media audience viewing said multimedia distribution on a multimedia viewing device, either live or via a delay;
providing an agent-object comprising one or more images of either a computer-generated cartoon character, or an actor, or a combination thereof, and an associated audio track;
combining said images and said audio track of said agent-object with said multimedia distribution using match moving methodology such that said agent-object is visible and audible only to said media audience and appears to said media audience to be present at said venue;
initiating a change of said display-object being displayed on said locally-located signage-display, said display-object and said change being visible to said spectators present at said venue and to said media audience; and
having said agent-object perform one or more actions, visible and audible only to said media audience, said actions being executed so as to coincide with said change of said display-object being displayed on said locally-located signage-display such that said agent-object appears to said media audience to be real, and to be causing said change of said display-object being displayed on said locally-located, signage display.

2. The method of claim 1 wherein said locally-located, changeable signage-display is a rotating perimeter board.

3. The method of claim 1 wherein said locally-located, changeable signage-display is an LED equipped, digital perimeter board.

4. The method of claim 1 in which said event occurring in said venue is a soccer match.

5. A system of enhancing a multimedia information stream, comprising:
a changeable signage-display located locally within a venue at which an event is occurring that is being recorded for distribution to a media audience, such that a display-object displayed on said locally-located, changeable signage-display is visible and audible to spectators present at said venue;
at least one broadcast quality camera and one broadcast quality microphone positioned, and functionally enabled, to provide a primary image source and a primary audio source incorporating images and audio signals representative of said display-object for said distribution of said multimedia information stream to said media audience;
a match-moving graphics and audio engine functionally enabled to obtain said primary image and audio sources and combine them with one or more secondary image and audio sources representative of an agent-object, comprising either a computer generated character, or an actor, or a combination thereof; to provide a composite multimedia stream of video images and an audio track;
initiating a change of said display-object being displayed on said locally-located, changeable signage-display; and
coordinating an execution of one or more actions of said agent-object, visible and audible only to said media audience, to coincide with said change of said display-object being displayed on said locally-located signage-display such that said agent object appears to said media audience to be real, and to be causing said change of said display-object being displayed on said locally-located, signage display.

6. The system of claim 5 wherein said locally-located, changeable signage-display is a rotating perimeter board.

7. The system of claim 5 wherein said locally-located, changeable signage-display is an LED equipped, digital perimeter board.

8. The system of claim 5 in which said event occurring in said venue is a soccer match.

9. The system of claim 5 where said match-moving graphics engine operates in real-time and comprises a suitably powerful and suitably programmed general purpose computer and the associated input, output and storage media.
